(19) United States
(12) Patent Application Publication
(10) Pub. No.: US 2012/0129694 A1
(43) Pub. Date: May 24, 2012

(54) HERBICIDAL CAPSULE SUSPENSIONS OF ACETOCHLOR CONTAINING REDUCED AMOUNTS OF SAFENER

(75) Inventors: Scott Ditmarsen, Madison, WI (US); Douglas J. Linscott, Pittsboro, IN (US); Stephen L. Wilson, Zionsville, IN (US); Phillip J. Howard, Zionsville, IN (US); David G. Ouse, Indianapolis, IN (US); Brandon M. Downer, Lebanon, IN (US); Eric Scherder, Huxley, IA (US); Joey Cobb, Noblesville, IN (US); Mark Woodruff, Zionsville, IN (US); Ricardo Boeker, Zionsville, IN (US); Samuel M. Ferguson, Omaha, NE (US); Courtney Gallup, Davenport, IA (US)

(73) Assignee: DOW AGROSCIENCES LLC, Indianapolis, IN (US)

(21) Appl. No.: 13/299,391

(22) Filed: Nov. 18, 2011

Related U.S. Application Data
(60) Provisional application No. 61/416,338, filed on Nov. 23, 2010.

(51) Int. Cl. A01N 25/32; A01P 13/00; A01N 25/34

(52) U.S. Cl. 504/107; 504/112

(57) ABSTRACT

Aqueous herbicidal capsule suspensions of acetochlor, containing microcapsules of defined size, shell wall composition, and thickness which contain acetochlor and reduced levels of herbicide safener are provided. The aqueous herbicidal capsule suspensions of acetochlor provide commercially acceptable weed control and selectivity in corn.

This application claims the benefit of U.S. Provisional Patent Application Ser. No. 61/416,338, filed Nov. 23, 2010.

### BACKGROUND

Chloroacetamide herbicides such as, for example, acetochlor, alachlor, butachlor, dimethenamide, metolochlor, S-metolochlor and propachlor, are extensively used to control weeds in crops such as corn, peanuts, potatoes, soybeans, canola, sugarbeets, grain sorghum (milo), field beans and cotton. Depending on the nature of the chloroacetamide herbicide and the intended application or use, compositions of these herbicides may also include an herbicide safener or antidote.

Many herbicide safeners are well known in the art such as, for example, dichlormid (N,N-diallyl dichloroacetamide), 2,2,5-trimethyl-3-dichloroacetyl-oxazolidine (R-29148) and furilazole (3-(dichloroacetyl)-5-(2-furanyl)-2,2-dimethyloxazolidine). Herbicide safeners are used with herbicides in order to minimize or eliminate any phytotoxic effect the herbicide may have on the crop plant, while at the same time not diminishing the level of herbicidal activity on the target weeds. The use of herbicide safeners in modern agriculture has been described, for example, by J. Davies in “Herbicide Safeners—Commercial Products and Tools for Agrochemical Research,” in the Pesticide Outlook, February 2001, pg 10-15, The Royal Society of Chemistry 2001 (DOI: 10.1039/b100799h).

Microcapsule formulations of herbicides are normally used to achieve a controlled release of the encapsulated herbicide contained in the core of the capsule through the wall or shell wall of the capsule to the area of application. When properly done, the results are greater longevity of the encapsulated herbicide and longer availability of it for residual weed control in the soil, through controlled released. Controlled release of herbicides from microcapsules may also, at times, provide improved crop selectivity. Known microencapsulation procedures are generally adequate for producing formulations with good weed control; however, difficulty can be encountered when optimizing the release rate of a given herbicide active ingredient, and, optionally, a herbicide safener from the microcapsule to obtain acceptable weed control while minimizing crop injury to commercially acceptable levels.

For current microencapsulation technology, an herbicide contained in the core of a microcapsule is typically released, at least in part, by molecular diffusion through the shell wall. Modification of shell wall thickness to increase or decrease the herbicide release rate can be challenging. Thin shell walls may be sensitive to premature mechanical rupture during storage, handling or spray application in the field which can result in premature herbicide release. However, if the shell wall thickness is increased too much, the bioefficacy may quickly drop to a marginal performance level because herbicide release is delayed or too slow. There is also a practical limit to the wall thickness that can be achieved by interfacial polymerization since as the polymer precipitates, the reaction becomes diffusion controlled and therefore very slow.

### SUMMARY

Aqueous acetochlor capsule suspensions containing reduced levels of herbicide safeners are described. The aqueous acetochlor capsule suspensions containing reduced levels of herbicide safeners include a microcapsule containing, with respect to the capsule suspension, from about 200 g/L to about 700 g/L. The microcapsule includes a water insoluble polyurea shell wall, the water insoluble polyurea shell wall being prepared by an interfacial polycondensation reaction between a water soluble diamine monomer and an oil soluble polyisocyanate monomer in which the molar ratio of amine to isocyanate groups is less than 1.1, the shell wall has a thickness of greater than about 50 nm and less than about 150 nm, and the average particle size is from about 2 μm to about 15 μm, and an inner liquid core, the inner liquid core having, with respect to the capsule suspension, from about 200 grams per liter (g/L) to about 550 g/L of acetochlor and from about 0 g/L to about 50 g/L of an herbicide safener, wherein the weight ratio of the acetochlor to the herbicide safener is greater than about 10, wherein the weight ratio of the inner liquid core to the water insoluble polyurea shell wall is from about 6 to about 30. The aqueous acetochlor capsule suspensions containing reduced levels of herbicide safeners also include a continuous aqueous phase comprising, with respect to the capsule suspension, from about 250 g/L to about 750 g/L of water; and at least one of an emulsifying and a dispersing surfactant comprising, with respect to the capsule suspension, from about 1 g/L to about 100 g/L. The aqueous acetochlor capsule suspensions may optionally include one or more inert formulation ingredients. A method for improving safety to corn of herbicidal spray applications containing acetochlor includes using these aqueous acetochlor capsule suspensions.

Additionally, methods for preparing an aqueous microcapsule suspension containing acetochlor and a reduced amount of a herbicide safener are also described. The methods include combining water and water soluble or water dispersible ingredients with an oil-soluble dispersing or emulsifying surfactant, acetochlor, the herbicide safener, and a polyisocyanate monomer and forming an oil-in-water emulsion by high shear homogenization of the combination until a desired emulsion oil droplet size is achieved; and forming a polyurea capsule shell wall by adding a water soluble diamine monomer to the oil-in-water emulsion to provide the aqueous microcapsule suspension.

### DETAILED DESCRIPTION

Novel aqueous compositions including microencapsulated acetochlor and reduced amounts of a herbicide safener having improved biological performance and methods for preparing such compositions are described. Such compositions provide unexpected and surprising crop safety and equivalent or better weed control when compared to known microencapsulated acetochlor and herbicide safener compositions. Additionally, these compositions are useful for the selective control of weeds in both pre-emergent and post-emergent applications to corn.

In general, the encapsulated acetochlor herbicide compositions containing reduced amounts of herbicide safeners described herein are prepared by contacting an aqueous continuous phase containing a diamine monomer with a discontinuous oil phase containing acetochlor, a herbicide safener, and a polyisocyanate monomer. A polyurea shell wall is formed in a polymerization reaction between the diamine monomer and the polyisocyanate monomer at the oil/water interface of the previously emulsified oil-water mixture (oil-in-water emulsion) thereby forming a microcapsule with a liquid core containing acetochlor and the reduced amount of the herbicide safener.

Compositional and process variables that can be controlled to alter the aqueous dispersions of microencapsulated acetochlor herbicide containing reduced amounts of herbicide safeners described herein include, for example, the molar ratio of amine to isocyanate groups, the shell wall composition, the weight ratio of core material to shell wall material, the core material composition, the mean microcapsule particle size, processing conditions such as mixing shear and time, and combinations thereof. The aqueous dispersions of microencapsulated acetochlor herbicide containing reduced amounts of herbicide safeners described herein, when compared to known compositions and methods, cause less crop injury when used in pre-emergent and post-emergent applications to corn while simultaneously achieving commercially acceptable weed control. This improved crop safety is obtained even when using less than standard amounts of a herbicide safener in the liquid cores of the microcapsules in the aqueous dispersions described herein.

The microcapsule shell wall of the aqueous dispersions of microencapsulated acetochlor herbicide containing reduced amounts of herbicide safeners described herein preferably include a polyurea polymer formed by the reaction between a water soluble amine monomer having two amino groups per molecule and at least one oil soluble polyisocyanate monomer having two or more isocyanate groups per molecule by methods that are generally well known to those of skill in the art. Release of the acetochlor herbicide and herbicide safener core material from the microcapsule prepared as described herein is generally controlled by physical attributes of the microcapsules such as, for example, the composition of the microcapsule shell wall, the thickness of the shell wall, the weight ratio of the liquid core to the shell wall, and the size of the microcapsules.

The aqueous dispersions of microencapsulated acetochlor herbicide containing reduced amounts of herbicide safeners described herein can be prepared by encapsulating the liquid core material in a polyurea shell wall formed by reacting a water soluble diamine monomer and at least one oil soluble polyisocyanate monomer in a reaction medium in concentrations such that the reaction medium comprises less than 1.1 molar equivalents of amine groups compared to the isocyanate groups. Alternatively, the molar concentration of amine groups from the diamine monomer and the molar concentration of isocyanate groups from the at least one polyisocyanate monomer (i.e., one isocyanate, a blend of two isocyanates, a blend of three isocyanates, etc.) in the reaction medium is such that the ratio of the concentration of amine molar equivalents to the concentration of isocyanate molar equivalents is less than 1.1. For further example, the ratio of the concentration of amine molar equivalents to the concentration of isocyanate molar equivalents can be less than or equal to 1.0.

The polyurea capsule wall of the microcapsules as described herein can be formed by an interfacial polycondensation between at least one oil soluble monomer selected from the group consisting of polyisocyanates and at least one water soluble amine monomer selected from the group consisting of diamines. Examples of polyisocyanate monomers include polymethylene polyphenylisocyanates such as PAPI® 27 (trademark of The Dow Chemical Company; Midland, Mich.). Examples of water soluble diamine monomers include, but are not limited to, ethylenediamine, propylenediamine, isopropylenediamine, and the like. One specific example of useful components in an interfacial polycondensation to form a capsule wall includes PAPI® 27 and ethylenediamine. The microcapsules of the aqueous dispersions of microencapsulated acetochlor herbicide containing reduced amounts of herbicide safeners described herein have an average size of from about 2 micrometers (w) to about 15 μm. Additionally, the microcapsules of the aqueous dispersions of microencapsulated acetochlor herbicide containing reduced amounts of herbicide safeners described herein can have an average size of from 2 μm to 15 μm, from 3 μm to 12 μm, 4 μm to 10 μm, or 5 μm to 8 μm.

Release of the acetochlor and herbicide safener core material from microcapsules prepared as described herein is controlled mainly by the thickness of the capsule shell wall and by the weight ratio of the liquid core material to the capsule shell wall material. Capsules as described herein have a shell wall thickness from about 50 nanometers (nm) to about 150 nm. Additionally, the capsules as described herein can have a shell wall thickness from 50 nm to 150 nm, 60 nm to 140 nm, 70 nm to 130 nm, 80 nm to 120 nm, 90 nm to 115 nm, about 50 nm to about 80 nm, about 50 nm to 80 nm, about 50 nm to 70 nm, or about 50 nm to 60 nm. Capsules with a shell wall thickness less than about 50 nm may release the core material too quickly leading to an increased potential for crop injury and decreased residual weed control or they may be susceptible to mechanical degradation during storage and handling operations. Capsules with a shell wall thickness greater than about 150 nm may release the core material too slowly resulting in decreased weed control. The weight ratio of the liquid core to the capsule shell wall for the microcapsules as described herein is from about 6 to about 30, preferably from about 6 to about 20. Alternatively, the weight ratio of the liquid core to the capsule shell wall for the microcapsules as described herein is from 6 to 30, 6 to 25, 6 to 20, 6 to 15, 6 to 10.

The acetochlor used in the aqueous dispersions of microencapsulated acetochlor herbicide containing reduced amounts of herbicide safeners described herein comprises, with respect to the aqueous capsule suspension, from about 200 g/L to about 550 g/L, preferably from about 300 g/L to about 500 g/L. Alternatively, acetochlor can be used in the aqueous dispersions of microencapsulated acetochlor herbicide containing reduced amounts of herbicide safeners described herein can include, with respect to the aqueous capsule suspension, from 200 g/L to 550 g/L, 250 g/L to 500 g/L, 300 g/L to 500 g/L, 300 g/L to 450 g/L, or 350 g/L to 450 g/L. The microcapsule of the aqueous dispersions of microencapsulated acetochlor herbicide containing reduced amounts of herbicide safeners described herein comprises, with respect to the aqueous capsule suspension, from about 200 g/L to about 700 g/L, preferably from about 300 g/L to about 650 g/L. Alternatively, the microcapsule of the aqueous dispersions of microencapsulated acetochlor herbicide containing reduced amounts of herbicide safeners described herein can include, with respect to the aqueous capsule suspension, from 200 g/L to 700 g/L, 250 g/L to 650 g/L, 300 g/L to 650 g/L, 350 g/L to 600 g/L, 350 g/L to 550 g/L, 400 g/L to 550 g/L, or 400 g/L to 500 g/L.

The herbicide safener suitable for use with the aqueous dispersions of microencapsulated acetochlor herbicide containing reduced amounts of herbicide safeners described herein may be selected from, but is not limited to, benoxacor, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, mefenpyr, mephenate, naphthalic anhydride and oxabetrinil, and mixtures and derivatives thereof. Preferred herbicide safeners include dichlormid, furilazole and benoxacor. The herbicide safener, with respect to the aqueous capsule suspension as described herein, comprises from about 0 g/L to about 50 g/L. Alternatively, the herbicide safener, with respect to the aqueous capsule suspension as described herein, can include from about 0 g/L to 50 g/L, 5 g/L to 50 g/L, 5 g/L to 45 g/L, 10 g/L to 45 g/L, 10 g/L to 50 g/L, 10 g/L to 40 g/L, 15 g/L to 40 g/L, 15 g/L to 45 g/L, 15 g/L to 50 g/L, 20 g/L to 40 g/L, 20 g/L to 45 g/L, or 20 g/L to 50 g/L. Note the lower limit of 0 g/L is used intentionally to encompass an aqueous capsule suspension as described herein that includes no or substantially no safener, which situation is useful in some crops.

The herbicide safener contained within the microcapsule as described herein can be used in amounts that are greatly reduced compared to commonly used products and yet provide equivalent or improved crop safety. Factors that affect the amount of safener used in the aqueous dispersions of microencapsulated acetochlor herbicide containing reduced amounts of herbicide safeners described herein include, but are not limited to, the choice of the safener, the crop and weeds to be treated and the parameters used for design and preparation of the capsule, including the chemical composition of the shell wall, and their impact on release rates of the core materials as described herein. The amount of herbicide safener contained in the microcapsule as described herein is normally expressed as a weight ratio relative to the herbicide in the microcapsule. For the microcapsule as described herein, the weight ratio of acetochlor to the herbicide safener is greater than about 10 to 1. Alternatively, the weight ratio of acetochlor to the herbicide safener in the microcapsules described herein can be greater than 10 to 1, greater than 11 to 1, greater than about 12 to 1, greater than 12 to 1, greater than 13 to 1, greater than 14 to 1, greater than 16 to 1, greater than 18 to 1, or greater than 20 to 1. In some instances, and depending on the factors and uses described herein, a microcapsule may contain no herbicide safener and may be used to selectively control weeds in crops such as, for example, corn. The aqueous herbicidal microcapsule suspensions as described herein provide improved crop safety when used in pre-emergent or post-emergent spray applications to control weeds.

The liquid core of the microcapsules as described herein may optionally include a diluent. The diluent may include one or more water immiscible organic solvents that may serve to dilute the other components of the liquid core or change the solubility properties of the liquid core. For example, the diluent may help dissolve core components, such as the herbicide active ingredient or the herbicide safener, that are not liquid or easily flowable at temperatures that are suitable for making and using the microcapsule. Use of a diluent may also increase or decrease the release rates of the active ingredient and the safener from the microcapsule. Useful diluents are compatible with the core and shell wall of the microcapsule and the processing conditions used to make the microcapsule. Suitable organic solvents useful with the aqueous dispersions of microencapsulated acetochlor herbicide containing reduced amounts of herbicide safeners described herein are compatible with the polyurea microcapsules and with the conditions and methods used to prepare the polyurea microcapsules and may include, but are not limited to, one or more of petroleum fractions or hydrocarbons such as mineral oil, kerosene, paraffinic oils, mixed naphthalene and alkyl naphthalene fractions, aromatic solvents, particularly alkyl substituted benzenes such as xylene or propylbenzene fractions, and the like; dialkyl amides of carboxylic acids, particularly the dimethyl amides of fatty acids such as the dimethyl amide of caprylic acid and the like; vegetable or seed oils such as soybean oil, rape seed oil, olive oil, castor oil, sunflower seed oil, coconut oil, corn oil, cotton seed oil, linseed oil, palm oil, peanut oil, safflower oil, sesame oil, tung oil and the like; esters of the above vegetable and seed oils; chlorinated aliphatic and aromatic hydrocarbons such as 1,1,1-trichloroethane and chlorobenzene; ketones such as isophorone and trimethylcyclohexanone (dihydroisophorone); and acetate esters of C₄-C₁₀ alcohols such as hexyl, or heptyl acetate, and the like.

The continuous aqueous phase of the aqueous dispersions of microencapsulated acetochlor herbicide containing reduced amounts of herbicide safeners described herein includes water as the reaction medium for the polycondensation reaction used to from the microcapsules and as the aqueous solvent in which the microcapsules are suspended or dispersed and, optionally, other water soluble or water dispersible ingredients. The aqueous phase comprises, with respect to the capsule suspension, from about 250 g/L to about 750 g/L, preferably from about 300 g/L to about 600 g/L of water. Alternatively the aqueous phase, with respect to the capsule suspension, includes from 250 g/L to 750 g/L, 250 g/L to 700 g/L, 250 g/L to 650 g/L, 250 g/L to 600 g/L, 300 to 700 g/L, 300 g/L to 650 g/L, 300 g/L to 600 g/L, 350 g/L to 700 g/L, 350 g/L to 650 g/L, 350 g/L to 600 g/L, 350 g/L to 550 g/L, 350 g/L to 500 g/L, 400 g/L to 650 g/L, 400 g/L to 600 g/L, or 400 g/L to 550 g/L.

The oil-in-water emulsion is preferably formed by adding the oil phase containing the polyisocyanate monomer, acetochlor and the herbicide safener, if one is used, to the continuous aqueous phase to which one or more emulsifying and dispersing surfactants have been added. The surfactants serve to facilitate the formation and stabilization of the oil-in-water emulsion from which the microcapsule as described herein is formed. The size of the oil droplets formed in the oil-in-emulsion is impacted by a number of factors including the choice of surfactant and the time and rate of shear mixing employed. The size of the oil droplets formed in the oil-in-water emulsion determines the size of microcapsules formed in the subsequent polyurea microencapsulation chemistry.

Surfactants included in the aqueous dispersions of microencapsulated acetochlor herbicide containing reduced amounts of herbicide safeners described herein aid in the oil-in-water emulsion-forming process prior to the polyamine addition, as well as, to enhance the physical stability (e.g. to prevent agglomeration) of the microcapsules once formed. Surfactants useful with the aqueous dispersions of microencapsulated acetochlor herbicide containing reduced amounts of herbicide safeners described herein may include one or more of an emulsifying agent and a dispersing agent such as salts of alkyl sulfates, such as sodium lauryl sulfate; alkylarylsulfonate salts, such as calcium dodecylbenzenesulfonate; alkylphenol alkoxylates, such as nonylphenol-C₁₈ ethoxylate; aliphatic alcohol alkoxylates, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; sodium lignosulfonates; sodium naphthalene sulfonate formaldehyde condensates; tristyrylphenol ethoxylate phosphate esters; and polymeric surfactants, such as poly(vinyl alcohol), polyacrylates, and ‘comb’ surfactants containing hydrophobic ‘backbones’ and a large number of ethylene oxide chains forming the ‘teeth’ of the ‘comb’. A surfactant blend used herein and referred to as “Surfactant Blend A” is a mixture of anionic and nonionic surfactants that contains calcium dodecylbenzenesulfonate, an isobutanol initiated EO-PO block copolymer and a petroleum hydrocarbon solvent.

Surfactants useful with the aqueous dispersions of microencapsulated acetochlor herbicide containing reduced amounts of herbicide safeners described herein include at least one of an emulsifying and a dispersing surfactant comprising, with respect to the capsule suspension, from about 1 g/L to about 100 g/L. Alternatively, the surfactants useful with the aqueous dispersions of microencapsulated acetochlor herbicide including reduced amounts of herbicide safeners described herein include at least one of an emulsifying and a dispersing surfactant including, with respect to the capsule suspension, from 1 g/L to 100 g/L, 5 g/L to 100 g/L, 5 g/L to 90 g/L, 5 g/L to 80 g/L, 5 g/L to 70 g/L, 5 g/L to 50 g/L, 10 g/L to 100 g/L, 10 g/L to 90 g/L, 10 g/L to 80 g/L, 10 g/L to 70 g/L, 10 g/L to 50 g/L, 15 g/L to 95 g/L, 15 g/L to 85 g/L, 15 g/L to 75 g/L, 15 g/L to 65 g/L, 15 g/L to 50 g/L, 20 g/L to 90 g/L, 20 g/L to 80 g/L, 20 g/L to 70 g/L, 20 g/L to 50 g/L, 30 g/L to 90 g/L, 30 g/L to 80 g/L, 30 g/L to 70 g/L, 30 g/L to 50 g/L, or 40 g/L to 60 g/L.

The composition as described herein may optionally include one or more inert ingredients such as, but not limited to, antifreeze agents, antifoam agents, antimicrobial agents, compatibilizing agents, corrosion inhibitors, dispersing agents, dyes, emulsifying agents, freezing point depressants, neutralizing agents and buffers, odorants, penetration aids, sequestering agents, spreading agents, stabilizers, sticking agents, suspension aids, thickening agents and the like.

In a typical procedure for preparing the compositions as described herein, the aqueous phase is prepared by mixing water with the water soluble or water dispersible ingredients including, but not limited to, water soluble or water dispersible dispersing or emulsifying surfactants and, optionally, other inert ingredients such as wetting agents, antifoam agents, etc. The oil phase is prepared by mixing oil-soluble dispersing or emulsifying surfactants with oil miscible or soluble ingredients, including but not limited to, acetochlor, the herbicide safener if one is used and the polyisocyanate monomer. An emulsion is prepared by slowly adding the oil phase to the aqueous phase under high shear homogenization until the desired emulsion droplet size (2-15 μm) is achieved. The polyurea capsule shell wall is then formed by adding the water soluble diamine monomer to the emulsion with moderate stiffing to provide the microcapsule suspension with an average capsule size from about 2 μm to about 15 μm. Additional inert formulation ingredients such as, but not limited to, thickeners, antifreeze agents and biocides may then be added to the freshly prepared microcapsule suspension to provide the compositions as described herein.

An example of an aqueous acetochlor capsule suspension as described herein containing reduced amounts of the herbicide safener dichlormid comprises:
a) a microcapsule having a water insoluble polyurea shell wall prepared by an interfacial polycondensation reaction between ethylenediamine monomer and PAPI® 27 monomer wherein
(i) the molar ratio of amine to isocyanate groups is less than 1.1,
(ii) the shell wall has a thickness of greater than about 50 nanometers (nm) and less than about 150 nm,
(iii) the microcapsule has an average particle size from about 2 micrometers (μm) to about 10 μm,
(iv) the microcapsule contains an inner liquid core comprised of, with respect to the capsule suspension, from about 300 g/L to about 500 g/L of acetochlor and from about 0 g/L to about 50 g/L of the herbicide safener dichlormid, where the weight ratio of the acetochlor to dichlormid is greater than about 10, and
(v) the weight ratio of the liquid core to the polyurea shell wall is from about 6 to about 20,
comprising, with respect to the capsule suspension, from about 300 g/L to about 650 g/L;
b) a continuous aqueous phase comprising, with respect to the capsule suspension, from about 300 g/L to about 650 g/L of water; and
c) at least one of an emulsifying and a dispersing surfactant together comprising, with respect to the capsule suspension, from about 1 g/L to about 100 g/L of Surfactant Blend A and Kraftsperse 25M.

Another aspect of the aqueous dispersions of microencapsulated acetochlor herbicide containing reduced amounts of herbicide safeners described herein concerns a method of improving safety to corn in herbicidal spray applications containing acetochlor which comprises encapsulating acetochlor and the herbicide safener in a water insoluble polyurea shell wall prepared by an interfacial polycondensation reaction between a water soluble diamine monomer and an oil soluble polyisocyanate monomer wherein (i) the molar ratio of amine to isocyanate groups is less than 1.1, (ii) the shell wall having a thickness of greater than about 50 nanometers (nm) and less than about 150 nm, (iii) the average particle size of the microcapsule is from about 2 micrometers (μm) to about 15 μm, and (iv) the weight ratio of the liquid core containing the acetochlor and the herbicide safener to the polyurea shell wall is from about 6 to about 30.

Another aspect of the present invention concerns a method of preparing the aqueous microcapsule suspension containing acetochlor and the reduced amount of the herbicide safener, the method comprising:
a) combining water and water soluble or water dispersible ingredients with an oil-soluble dispersing or emulsifying surfactant, acetochlor, the herbicide safener, and a polyisocyanate monomer and forming an oil-in-water emulsion by high shear homogenization of the combination until a desired emulsion oil droplet size is achieved; and
b) forming a polyurea capsule shell wall by adding a water soluble diamine monomer to the oil-in-water emulsion to provide the aqueous microcapsule suspension; and
c) optionally adding any optional inert formulation ingredients to the microcapsule suspension.
   The above method for preparing the aqueous microcapsule suspension of the aqueous dispersions of microencapsulated acetochlor herbicide containing reduced amounts of herbicide safeners described herein can be operated in either a batch or continuous mode by one of ordinary skill in the art.

In addition to acetochlor, other chloroacetamide herbicides suitable for use with the aqueous dispersions of microencapsulated acetochlor herbicide containing reduced amounts of herbicide safeners described herein may be selected from alachlor, butachlor, butenachlor, delachlor, diethatyl, dimethachlor, dimethenamid, dimethenamid-P, mefenacet, metazochlor, metolachlor, S-metolachlor, pretilachlor, propachlor, propisochlor, prynachlor, terbuchlor, thenylchlor and xylachlor, mixtures thereof and stereoisomers thereof.

The aqueous herbicidal capsule suspensions as described herein may optionally be diluted in an aqueous spray mixture for agricultural application such as for selective weed control in corn. Such compositions are typically diluted with an inert carrier, such as water, before application. The diluted compositions, which are usually applied to weeds, the locus of weeds or the locus of where weeds may eventually emerge, generally contain about 0.0001 to about 1 weight percent active ingredient and preferably contain about 0.001 to about 0.05 weight percent active ingredient. Alternatively, the diluted compositions may contain 0.0001 to 1 weight percent active ingredient, 0.001 to 0.05 weight percent active ingredient, 0.0001 to 0.5 weight percent active ingredient, 0.01 to 0.5 weight percent active ingredient, 0.1 to 0.5 weight percent active ingredient, 0.0001 to 0.25 weight percent active ingredient, 0.001 to 0.25 weight percent active ingredient, 0.01 to 0.25 weight percent active ingredient, or 0.1 to 0.25 weight percent active ingredient. The present compositions can be applied to weeds or their locus by the use of conventional ground or aerial sprayers, by addition to irrigation water and by other conventional means known to those skilled in the art.

The herbicidal compositions as described herein may be applied in conjunction with one or more other herbicides to control a wider variety of undesirable vegetation. When used in conjunction with other herbicides, the presently claimed compositions can be formulated with the other herbicide or herbicides as premix concentrates, tank mixed with the other herbicide or herbicides for spray application or applied sequentially with the other herbicide or herbicides in separate spray applications.

Suitable herbicides for use in conjunction with the compositions as described herein may be selected from, but are not limited to, atrazine, benfuresate, bentazone, butafenacil, clomazone, clopyralid, cyanazine, dicamba, diflufenzopyr, diuron, EPTC, florasulam, flufenacet, flumetsulam, flumiclorac-pentyl, fluoroxypyr, foramsulfuron, fumiclorac, glufosinate, glufosinate-ammonium, halosulfuron, isoxaflutole, pyroxasulfone, linuron, mesotrione, metosulam, metribuzin, nicosulfuron, oxyfluorfen, pendimethalin, primisulfuron, prosulfuron, rimsulfuron, simazine, sulcotrion, terbuthylazin, thifensulfuron and thifensulfuron-methyl.

An example of an aqueous capsule suspension as described herein used in conjunction with the suitable herbicides described herein comprises a capsule suspension containing a mixture of acetochlor and the herbicide safener dichlormid in the liquid core of the capsule and an aqueous dispersion of atrazine in the continuous aqueous phase. Such aqueous pre-mix herbicidal concentrates may be diluted from 1 to 2000 fold in water at the point of use depending on the agricultural practices and used in pre-emergent and post-emergent spray applications to control weeds in crops. This herbicidal concentrate may also contain the herbicide safener furilazole in place of dichlormid.

Another suitable example of an aqueous capsule suspension as described herein used in conjunction with the other herbicides described herein comprises a capsule suspension containing a mixture of acetochlor and the herbicide safener dichlormid in the liquid core of the capsule, and an aqueous dispersion of flumetsulam and an aqueous solution of clopyralid ethanolamine salt in the continuous aqueous phase. Such aqueous pre-mix herbicidal concentrates may be diluted from 1 to 2000 fold in water at the point of use depending on the agricultural practices and used in pre-emergent and post-emergent spray applications to control weeds in crops. This herbicidal concentrate may also contain the herbicide safener furilazole in place of dichlormid.

It is usually desirable to incorporate one or more surface-active agents into the tank mixtures or aqueous premix concentrates formed with the compositions as described herein used in conjunction with the other herbicides also as described herein. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Surfactants conventionally used in the art of formulation and which may also be used in the present formulations are described, inter alia, in “McCutcheon's Detergents and Emulsifiers Annual”, MC Publishing Corp., Ridgewood, N.J., 1998 and in “Encyclopedia of Surfactants”, Vol. I-III, Chemical publishing Co., New York, 1980-81. Typical surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable oils such as soy bean oil, rape seed oil, olive oil, castor oil, sunflower seed oil, coconut oil, corn oil, cotton seed oil, linseed oil, palm oil, peanut oil, safflower oil, sesame oil, tung oil and the like; and esters of the above vegetable oils.

In addition to the compositions and uses set forth above, the aqueous dispersions of microencapsulated acetochlor herbicide containing reduced amounts of herbicide safeners described herein also embrace the use of these aqueous herbicide capsule compositions in combination with one or more additional compatible ingredients such as antifoam agents, antimicrobial agents, compatibilizing agents, corrosion inhibitors, dispersing agents, dyes, emulsifying agents, freezing point depressants, neutralizing agents and buffers, odorants, penetration aids, sequestering agents, spreading agents, stabilizers, sticking agents, suspension aids, thickening agents and the like. The compositions may also contain other compatible components, for example, other herbicides, plant growth regulants, fungicides, insecticides, and the like, and may be formulated with liquid fertilizers.

The aqueous herbicidal capsule compositions as described herein can additionally be employed to control undesirable vegetation in many crops that have been made tolerant to or resistant to them or to other herbicides by genetic manipulation or by mutation and selection. The herbicidal compounds as described herein can, further, be used in conjunction with glyphosate, glufosinate, dicamba, imidazolinones or 2,4-D on glyphosate-tolerant, glufosinate-tolerant, dicamba-tolerant, imidazolinone-tolerant or 2,4-D-tolerant crops. Preferrably the compounds as described herein are used in combination with herbicides that are selective for the crop being treated and which complement the spectrum of weeds controlled by these compounds at the application rate employed. Further the compounds as described herein are generally applied with other complementary herbicides at the same time, either as a combination formulation or as a tank mix. Similarly the herbicidal compounds of as described herein can be used in conjunction with acetolactate synthase inhibitors on acetolactate synthase inhibitor tolerant crops.

The following examples illustrate the present invention.

### Example 1

### Preparation of Formulation A

An organic phase comprised of 1763 g of acetochlor technical, 146.9 g of dichlormid technical, and 90.0 g of PAPI® 27 (Dow Chemical; Midland, Mich.) was emulsified into an aqueous phase comprised of 100.0 g of Kraftsperse® 25M (Mead Westvaco; Richmond, Va.), 20.0 g of Surfactant Blend A, 5.0 g of Proxel® GXL (Arch Chemicals; Smyrna, Ga.), 10.0 g of Avicel® CL 611 (FMC Biopolymers; Philadelphia, Pa.), 1.20 g of Kelzan® S(CPKelco; Atlanta, Ga.), and 1864 g of deionized water using a Silverson homogenizer (Silverson; Cincinnati, Ohio) fitted with a standard emulsion head. The speed of the homogenizer was gradually increased until the volume median particle size was ca. 8 μm (achieved at ca. 5000 rpm) as measured using a Malvern Mastersizer 2000 laser diffraction particle analyzer (Malvern; Westborough, Mass.). The polyurea capsule wall was then formed by adding 216.1 g of a 10% aqueous ethylenediamine (Aldrich; St. Louis, Mo.) solution with moderate stiffing. Finally 262.2 g of deionized water was added to yield a 400 g/L acetochlor (calculated density=1.064 g/mL, 95.5% technical purity) capsule suspension formulation. The resulting final volume median particle size was 7.9 μm as measured using the Mastersizer 2000.

### Example 2

### Preparation of Formulation B

An organic phase comprised of 1736 g of acetochlor technical, 144.6 g of dichlormid technical, and 119.7 g of PAPI® 27 was emulsified into an aqueous phase comprised of 100.0 g of Kraftsperse® 25M, 20.0 g of Surfactant Blend A, 5.0 g of Proxel® GXL, 10.0 g of Avicel® CL 611 (FMC Biopolymers; Philadelphia, Pa.), 1.20 g of Kelzan® S, and 1864 g of deionized water using a Silverson homogenizer fitted with a standard emulsion head. The speed of the homogenizer was gradually increased until the volume median particle size was ca. 8 μm (achieved at ca. 5000 rpm) as measured using a Malvern Mastersizer 2000 laser diffraction particle analyzer. The polyurea capsule wall was then formed by adding 287.3 g of a 10% aqueous ethylenediamine solution with moderate stiffing. Finally 127.7 g of deionized water was added to yield a 400 g/L acetochlor (calculated density=1.065 g/mL, 95.5% technical purity) capsule suspension formulation. The resulting final volume median particle size was 8.2 μm as measured using the Mastersizer 2000.

### Calculations for Determining Microcapsule Shell Wall Thickness for Formulations A & B

The calculation of the amounts of capsule wall components needed to achieve a target wall thickness was based on the geometric formula relating the volume of a sphere to its radius. If a core-shell morphology is assumed, with the core comprised of the non wall-forming, water insoluble components (herbicide and herbicide safener) and the shell wall made up of the polymerizable materials (oil and water soluble monomers), then equation (1) holds, relating the ratio of the volume of the core (V_{C}) and the volume of the core, plus the volume of the shell (Vₛ) to their respective radii, where r_{S} is radius of the capsule including the shell and lₛ is thickness of the shell.

$$\frac{{V}_{c} + {V}_{s}}{ {V}_{c}} = {( \frac{{r}_{s}}{{r}_{s} - {l}_{s}} )}^{3} \qquad ( 1 )$$

Solving equation (1) for the volume of the shell yields:

$${V}_{S} = {V}_{C} ( {( \frac{{r}_{S}}{{r}_{S} - {l}_{S}} )}^{3} - 1 ) \qquad ( 2 )$$

Substituting masses (mᵢ) and densities (dᵢ) for their respective volumes (m_{S}/d_{S}=V_{S} and m_{C}/d_{C}=V_{C}, where the subscript s or c refers to the shell or core, respectively) and solving for the mass of the shell gives:

$${m}_{S} = {m}_{C} \frac{{d}_{S}}{{d}_{C}} ( {( \frac{{r}_{S}}{{r}_{S} - {l}_{S}} )}^{3} - 1 ) \qquad ( 3 )$$

In order to simplify the calculation and directly use the respective weights of the capsule core and shell components the approximation that the density ratio dₛ/d_{c} is approximately equal to one was made yielding equation (4).

$${m}_{S} \approx {m}_{C} ( {( \frac{{r}_{S}}{{r}_{S} - {l}_{S}} )}^{3} - 1 ) \qquad ( 4 )$$

Making the substitutions m_{C}=m_{O}−m_{OSM}, m_{S}=m_{O}+(f_{WSM/OSM)})m_{OSM}−m_{C}, and f_{WSM/OSM}=m_{WSM}/m_{OSM} (the ratio of water soluble monomer to oil soluble monomer), where m_{O} is the total mass of the oil components (herbicide, herbicide safener and oil-soluble monomer), m_{OSM} is the mass of the oil-soluble monomer, and m_{WSM} is the mass of the water-soluble monomer, and solving for m_{OSM} yields:

$${m}_{OSM} = \frac{{m}_{O} ( {( \frac{{r}_{S}}{{r}_{S} - {l}_{S}} )}^{3} - 1 )}{{f}_{WSM / OSM} + {( \frac{{r}_{S}}{{r}_{S} - {l}_{S}} )}^{3}} \qquad ( 5 )$$

In Examples 1 and 2, the water-soluble monomer was used on a 1.07:1 equivalent basis relative to the oil-soluble monomer for all of the capsule suspension preparations.

### Example 3

### Greenhouse Evaluation of Corn Injury from Preemergent Applications

A number of acetochlor containing aqueous microcapsule suspensions as described herein were tested in the greenhouse in preemergent herbicide spray applications for their selectivity to corn. Treatments were applied with a track sprayer manufactured by Allen Machine Works (Midland, Mich.). The sprayer utilized an 8002E spray nozzle, spray pressure of 262 kiloPascals (kPa) pressure and speed of 2.2 miles per hour (mph) (3.54 kilometers per hour (kph)) to deliver 187 liters per hectare (L/Ha). The nozzle height was 46 centimeters (cm) above the pots. A greenhouse mineral soil:grit (80:20 ratio) was used and had the following analysis: sand, silt, and clay of 36, 42, and 23%, respectively, and classified as a loam with a pH of 7.9, organic matter of 2.4% and cation exchange capacity (CEC) of 10.4 meq/100 g. Plant material was grown in a greenhouse with day and night temperatures targeted at 26 to 28° C. Natural light was supplemented with 1000-watt metal halide overhead lamps with an average illumination of 500 microEinsteins per square meter per second (μE m⁻² s⁻¹) photosynthetic active radiation (PAR). Day length was 16 hours. Plant material was top watered throughout the duration of the experiment with clean city tap water. Plant stand counts were taken at 7 to 14 days after application depending on the time required for germination of each species. Percent visual injury assessments were made on a scale of 0 to 100% as compared to the untreated control plants (where 0 is equal to no injury and 100 is equal to complete death of the plant).

The acetochlor herbicide compositions used for preemergent spray treatments 1-6 in Table 1 are capsule suspensions of aqueous dispersions of microencapsulated acetochlor herbicide containing reduced amounts of herbicide safeners described herein, whereas the acetochlor herbicide compositions used for treatments 7a-c in Table 1 are shown for comparative purposes. Compositions used for treatments 1-4 and 7a in Table 1 were prepared in a similar manner to Formulation A and Formulation B (described in Examples 1 and 2) by modifying the experimental parameters used to form the various capsules in a manner that is well known to those of normal skill in the art.

The percent injury to corn was determined for each of the acetochlor treatments shown in Table 1. All of the inventive treatments (treatments 1-6) showed less corn injury than the comparative treatments (treatments 7a-c). The comparative treatments included an encapsulated acetochlor/dichlormid composition where the shell wall thickness was 10 nm (Treatment 7a), the commercial microencapsulated acetochlor/dichlormid product known as Topnotch® herbicide (Treatment 7b) and a typical emulsifiable concentrate (EC) formulation of acetochlor containing no safener (Treatment 7c).

TABLE 1
Greenhouse Study of Corn Injury Resulting from Pre-emergent Spray Applications
of Acetochlor Capsule Suspensions of the Present Invention Containing Reduced
Dichlormid Safener

| | | Acetochlor | Wt. Ratio of | Capsule | Weight | Corn |
|---|---|---|---|---|---|---|
| | | Use Rate | Herbicide to | Dimension (size/ | ratio core/polyurea | Injury |
| | Treatment Description | (g ai/ha) | Safener | shell thickness) | wall | (%) |
| 1 | encapsulated acetochlor | 2688 | no safener | 3 μm/50 nm | 9.3:1 | 3.5 |
| 2 | encapsulated acetchlor/dichlormid | 2688 | 12 to 1 | 3 μm/50 nm | 9.3:1 | 1.3 |
| 3 | encapsulated acetochlor | 2688 | no safener | 8 μm/50 nm | 24.8:1 | 12.5 |
| 4 | encapsulated acetchlor/dichlormid | 2688 | 12 to 1 | 8 μm/50 nm | 26.0:1 | 7.5 |
| 5 | Formulation A | 2520 | 12 to 1 | 8 μm/75 nm | 17.1:1 | 1.3 |
| 6 | Formulation B | 2520 | 12 to 1 | 8 μm/100 nm | 12.7:1 | 1.8 |
| 7a | encapsulated acetchlor/dichlormid | 2688 | 12 to 1 | 8 μm/10 nm | 132.5:1 | 41.3 |
| 7b | Topnotch ® herbicide | 2688 | 6 to 1 | 8 μm/112 nm | 11.4:1 | 13.8 |
| 7c | acetochlor EC | 2688 | no safener | na | na | 30 |

Topnotch ® herbicide (Dow AgroSciences LLC; Indianapolis, IN) is an aqueous microcapsule suspension containing 383 g ai/L of acetochlor and 64 g/L of dichlormid with a polyurea microcapsule shell wall prepared by the interfacial polycondensation reaction of a mixture of polymethylene polyphenylisocyanate and tolylene diisocyanate w/ use of no diamine monomer;
na = not applicable.

### Example 4

### Field Evaluation of Encapsulated Acetochlor Suspensions Applied to Corn

Acetochlor containing aqueous microcapsule suspensions as described herein were evaluated in field trials to determine their efficacy on weeds and selectivity to corn. Corn was planted at each trial location utilizing an available commercial hybrid appropriate for that geography and local growing conditions. Immediately after planting, preemergence treatments were broadcast applied to the soil surface. Following crop emergence, when corn reached the V2-V3 stage of growth (2-3 visible leaf collars), postemergence treatments were broadcast applied over the top of the crop. Herbicide treatments were applied at ½×, 1×, or 2× rates according to recommended product label rates, which varied by soil type. Table 2 lists the herbicide application rates for the various soil types in the trials. Crop tolerance evaluations of all treatments, expressed as a percent visual estimate of growth inhibition, chlorosis, necrosis, and overall injury relative to untreated plots, were conducted approximately 3, 7, 14, and 28 days after postemergence applications. Efficacy evaluations of all treatments, by weed species present and expressed as a percent visual estimate of control relative to untreated plots, were conducted approximately 14, 28, 42, and 56 days after postemergence applications.

TABLE 2
Herbicide Application Rates by Soil Type
1X Rates by Soil Type:

1X Rates (g ai/ha)
Soil Organic Matter Content

| Soil Texture* | Less than 3% | 3% or Greater |
|---|---|---|
| Coarse | | |
| Keystone | 3381 (2.3 qts/ac) | 3675 (2.5 qts/ac) |
| Formulation A | 1932 | 2100 |
| Formulation B | 1932 | 2100 |
| Aatrex L | 1288 | 1400 |
| Degree Xtra | 3280 (2.9 qts/ac) | 3280 (2.9 qts/ac) |
| Medium | | |
| Keystone | 3822 (2.6 qts/ac) | 3969 (2.7 qts/ac) |
| Formulation A | 2184 | 2268 |
| Formulation B | 2184 | 2268 |
| Aatrex L | 1456 | 1512 |
| Degree Xtra | 3733 (3.3 qts/ac) | 3733 (3.3 qts/ac) |
| Fine | | |
| Keystone | 4116 (2.8 qts/ac) | 4410 (3.0 qts/ac) |
| Formulation A | 2352 | 2520 |
| Formulation B | 2352 | 2520 |
| Aatrex L | 1568 | 1680 |
| Degree Xtra | 3903 (3.45 qts/ac) | 3903 (3.45 qts/ac) |

*Soil textural classes: Coarse = Sand, loamy sand, sandy loam; Medium = Loam, silt, silt loam; Fine = silty clay loam, sandy clay loam, sandy clay, silty clay, clay loam, clay.
Additional Notes for Table 2:
1 qt/ac Keystone = 1.3125 lb ai/ac = 0.75 lb ai/ac acetochlor + 0.5625 lb ai/ac atrazine
1 qt/ac Keystone = 1470 g ai/ha = 840 g ai/ha acetochlor + 630 g ai/ha atrazine
Keystone: acetochlor:atrazine ratio is 1.3333:1
Formulation 1 or Formulation 2 + Aatrex L: acetochlor:atrazine ratio is 1.50:1
1 qt/ac Degree Xtra = 1.01 lb ai/ac = 1131.2 g ai/ha

Tables 3 and 4 contain weed efficacy data for preemergent and postemergent applications, respectively, of 2 compositions of the present invention (Formulation A and Formulation B) and the commercial herbicide products Keystone® and Degree Xtra® to 3 weed species commonly found in corn. Tables 5 and 6 contain corn injury data for preemergent and postemergent applications, respectively, of 2 compositions of the present invention (Formulation A and Formulation B) and the commercial herbicide products Keystone® and Degree Xtra®. Keystone® herbicide (Dow AgroSciences LLC; Indianapolis, Ind.) is a suspoemulsion containing 360 g ai/L of acetochlor, 60 g/L of the safener dichlormid and 264 g ai/L of atrazine. Degree Xtra® herbicide (Monsanto; Creve Coeur, Mo.) is an aqueous microcapsule suspension containing 324 g ai/L of encapsulated acetochlor and the safener furilazole, and a dispersion of 161 g ai/L of atrazine.

TABLE 3
Weed Control Resulting from Pre-emergent Spray Application of
Tank Mixtures Containing (1) Acetochlor Capsule Suspensions
Containing Safener and (2) an Aqueous Suspension of Atrazine

| Treatment | | | % Visual Plant Injury¹ | | |
|---|---|---|---|---|---|
| Number | Description | Rate | ABUTH | SETFA | PANDI |
| 1 | Keystone ® | ½X | 53 | 100 | 66 |
| 2 | Formulation A + | ½X | 43 | 100 | 75 |
| | atrazine² | | | | |
| 3 | Formulation B + | ½X | 49 | 100 | 74 |
| | atrazine² | | | | |
| 4 | Keystone ® | 1X | 69 | 100 | 88 |
| 5 | Formulation A + | 1X | 65 | 100 | |
| | atrazine² | | | | |
| 6 | Formulation B + | 1X | 79 | 100 | 90 |
| | atrazine² | | | | |
| 7 | Degree Xtra ® | 1X | 55 | 100 | 20 |

¹ABUTH (velvetleaf) and SETFA (giant foxtail) treatments were evaluated 54 days after herbicide application; PANDI (fall panicum) treatments were evaluated 39 days after herbicide application;
² atrazine supplied as Aatrex ® L (Syngenta).

TABLE 4
Weed Control Resulting from Post-emergent Spray Application of
Tank Mixtures Containing (1) Acetochlor Capsule Suspensions
Containing Safener and (2) an Aqueous Suspension of Atrazine

| Treatment | | | % Visual Plant Injury¹ | | |
|---|---|---|---|---|---|
| Number | Description | Rate | ABUTH | SETFA | PANDI |
| 1 | Keystone ® | ½X | 53 | 48 | 36 |
| 2 | Formulation A + | ½X | 53 | 58 | 28 |
| | atrazine² | | | | |
| 3 | Formulation B + | ½X | 55 | 60 | 44 |
| | atrazine² | | | | |
| 4 | Keystone ® | 1X | 48 | 45 | 28 |
| 5 | Formulation A + | 1X | 86 | 78 | 55 |
| | atrazine² | | | | |
| 6 | Formulation B + | 1X | 84 | 79 | 56 |
| | atrazine² | | | | |
| 7 | Degree Xtra ® | 1X | 55 | 55 | 25 |

¹ABUTH (velvetleaf) and SETFA (giant foxtail) treatments were evaluated 29 days after herbicide application; PANDI (fall panicum) treatments were evaluated 28 days after herbicide application;
²atrazine supplied as Aatrex ® L (Syngenta).

TABLE 5
Corn Injury Resulting from Pre-emergent Spray Application of
Tank Mixtures Containing (1) Acetochlor Capsule Suspensions
Containing Safener and (2) an Aqueous Suspension of Atrazine

| Treatment | | | Mean Corn Injury¹ | |
|---|---|---|---|---|
| Number | Description | Rate | % Visual | Replicates |
| 1 | Keystone ® | 1X | 3 | 24 |
| 2 | Formulation A + atrazine² | 1X | 1 | 20 |
| 3 | Formulation B + atrazine² | 1X | 1 | 24 |
| 4 | Keystone ® | 2X | 4 | 24 |
| 5 | Formulation A + atrazine² | 2X | 3 | 24 |
| 6 | Formulation B + atrazine² | 2X | 1 | 24 |
| 7 | Degree Xtra ® | 1X | 0 | 24 |

¹Evaluated 14-30 days after treatment;
²atrazine supplied as Aatrex ® L (Syngenta; Wilmington, DE).

TABLE 6
Corn Injury Resulting from Post-emergent Spray Application of
Tank Mixtures Containing (1) Acetochlor Capsule Suspensions
Containing Safener and (2) an Aqueous Suspension of Atrazine

| Treatment | | | Mean Corn Injury¹ | |
|---|---|---|---|---|
| Number | Description | Rate | % Visual | Replicates |
| 1 | Keystone ® | 1X | 3 | 24 |
| 2 | Formulation A + atrazine² | 1X | 1 | 24 |
| 3 | Formulation B + atrazine² | 1X | 1 | 24 |
| 4 | Keystone ® | 2X | 18 | 24 |
| 5 | Formulation A + atrazine² | 2X | 2 | 22 |
| 6 | Formulation B + atrazine² | 2X | 2 | 24 |
| 7 | Degree Xtra ® | 1X | 1 | 24 |

¹Evaluated 2-4 days after treatment;
²atrazine supplied as Aatrex ® L (Syngenta).

The present invention is not limited in scope by the embodiments disclosed herein which are intended as illustrations of a few aspects of the invention and any embodiments which are functionally equivalent are within the scope of this invention. Various modifications of the compositions and methods in addition to those shown and described herein will become apparent to those skilled in the art and are intended to fall within the scope of the appended claims. Further, while only certain representative combinations of the composition components and method steps disclosed herein are specifically discussed in the embodiments above, other combinations of the composition components and method steps will become apparent to those skilled in the art and also are intended to fall within the scope of the appended claims. Thus a combination of components or method steps may be explicitly mentioned herein; however, other combinations of components and method steps are included, even though not explicitly stated. The term “comprising” and variations thereof as used herein is used synonymously with the term “including” and variations thereof and are open, non-limiting terms.

What is claimed:

1. An aqueous acetochlor capsule suspension containing reduced levels of herbicide safener comprising:
a) a microcapsule comprising, with respect to the capsule suspension, from about 200 g/L to about 700 g/L, the microcapsule comprising:
i) a water insoluble polyurea shell wall, the water insoluble polyurea shell wall being prepared by an interfacial polycondensation reaction between a water soluble diamine monomer and an oil soluble polyisocyanate monomer in which the molar ratio of amine to isocyanate groups is less than 1.1, the shell wall has a thickness of greater than about 50 nm and less than about 150 nm, and the average particle size is from about 2 μm to about 15 μm, and
ii) an inner liquid core, the inner liquid core having, with respect to the capsule suspension, from about 200 grams per liter (g/L) to about 550 g/L of acetochlor and from about 0 g/L to about 50 g/L of an herbicide safener, wherein the weight ratio of the acetochlor to the herbicide safener is greater than about 10,
wherein the weight ratio of the inner liquid core to the water insoluble polyurea shell wall is from about 6 to about 30;
b) a continuous aqueous phase comprising, with respect to the capsule suspension, from about 250 g/L to about 750 g/L of water; and
c) at least one of an emulsifying and a dispersing surfactant comprising, with respect to the capsule suspension, from about 1 g/L to about 100 g/L.

2. The aqueous acetochlor capsule suspension of claim 1, wherein the herbicide safener is benoxacor, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, mefenpyr, mephenate, naphthalic anhydride, oxabetrinil, or mixtures or derivatives thereof.

3. The aqueous acetochlor capsule suspension of claim 1, wherein the herbicide safener is dichlormid.

4. The aqueous acetochlor capsule suspension of claim 1, wherein the oil soluble polyisocyanate monomer is a polymethylene polyphenylisocyanate.

5. The aqueous acetochlor capsule suspension of claim 1, wherein the water soluble diamine monomer is ethylene diamine, propylenediamine or isopropylenediamine.

6. The aqueous acetochlor capsule suspension of claim 1, wherein the polyisocyanate monomer is a polymethylene polyphenylisocyanate and the water soluble diamine monomer is ethylene diamine.

7. The aqueous acetochlor capsule suspension of claim 1, wherein the dispersing surfactant is a mixture of calcium dodecylbenzenesulfonate, an isobutanol initiated EO-PO block copolymer, and a petroleum hydrocarbon solvent.

8. The aqueous acetochlor capsule suspension of claim 1, wherein the aqueous acetochlor capsule suspension further includes an additional herbicide.

9. The aqueous acetochlor capsule suspension of claim 8, wherein the additional herbicide is atrazine, benfuresate, bentazone, butafenacil, clomazone, clopyralid, cyanazine, dicamba, 2,4-dichlorophenoxyacetic acid, diflufenzopyr, diuron, EPTC, florasulam, flufenacet, flumetsulam, flumiclorac-pentyl, fluoroxypyr, foramsulfuron, fumiclorac, glyphosate, glufosinate, glufosinate-ammonium, halosulfuron, imidazolinones, isoxaflutole, pyroxasulfone, linuron, mesotrione, metosulam, metribuzin, nicosulfuron, oxyfluorfen, pendimethalin, primisulfuron, prosulfuron, rimsulfuron, simazine, sulcotrion, terbuthylazin, thifensulfuron, thifensulfuron-methyl, or mixtures thereof.

10. A method of improving safety to corn in herbicidal spray applications containing acetochlor which comprises using the aqueous acetochlor capsule suspension of claim 1.

11. A method of preparing an aqueous microcapsule suspension containing acetochlor and a reduced amount of a herbicide safener, the method comprising:
a) combining water and water soluble or water dispersible ingredients with an oil-soluble dispersing or emulsifying surfactant, acetochlor, the herbicide safener, and a polyisocyanate monomer and forming an oil-in-water emulsion by high shear homogenization of the combination until a desired emulsion oil droplet size is achieved; and
b) forming a polyurea capsule shell wall by adding a water soluble diamine monomer to the oil-in-water emulsion to provide the aqueous microcapsule suspension.

12. The method of claim 11, wherein the herbicide safener is benoxacor, cloquintocet, cyometrinil, dichlormid, dicyclonon, dietholate, fenchlorazole, fenclorim, flurazole, fluxofenim, furilazole, isoxadifen, jiecaowan, jiecaoxi, mefenpyr, mephenate, oxabetrinil, or mixtures or derivatives thereof.

13. The method of claim 11, wherein the herbicide safener is dichlormid.

14. The method of claim 11, wherein the herbicide safener is furilazole.

15. The method of claim 11, wherein the polyisocyanate monomer is a polymethylene polyphenylisocyanate.

16. The method of claim 11, wherein the water soluble diamine monomer is ethylene diamine, propylenediamine or isopropylenediamine.

17. The method of claim 11, wherein the polyisocyanate monomer is a polymethylene polyphenylisocyanate and the water soluble diamine monomer is ethylene diamine.

18. The method of claim 11, wherein the dispersing surfactant is a mixture of calcium dodecylbenzenesulfonate, an isobutanol initiated EO-PO block copolymer, and a petroleum hydrocarbon solvent.

19. The method of claim 11, further comprising adding an additional herbicide to the aqueous capsule suspension.

20. The method of claim 19, wherein the additional herbicide is atrazine, benfuresate, bentazone, butafenacil, clomazone, clopyralid, cyanazine, dicamba, 2,4-dichlorophenoxyacetic acid, diflufenzopyr, diuron, EPTC, florasulam, flufenacet, flumetsulam, flumiclorac-pentyl, fluoroxypyr, foramsulfuron, fumiclorac, glyphosate, glufosinate, glufosinate-ammonium, halosulfuron, imidazolinones, isoxaflutole, pyroxasulfone, linuron, mesotrione, metosulam, metribuzin, nicosulfuron, oxyfluorfen, pendimethalin, primisulfuron, prosulfuron, rimsulfuron, simazine, sulcotrion, terbuthylazin, thifensulfuron, thifensulfuron-methyl, or mixtures thereof.
